(19) United States
(12) Patent Application Publication
(10) Pub. No.: US 2003/0115811 A1
(43) Pub. Date: Jun. 26, 2003

(54) Snap hold frame

(76) Inventor: Peter Sibbett, Tacoma, WA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/300,948

(22) Filed: Nov. 20, 2002

Related U.S. Application Data
(60) Provisional application No. 60/331,926, filed on Nov. 21, 2001.

(51) Int. Cl. E06B 3/988; E06B 3/00

(52) U.S. Cl. 52/204.7; 52/204.55

(57) ABSTRACT

An attachment mechanism for joining two parts together including a female member and a male member for insertion into the female member in a snap-fit relationship is disclosed. The attachment mechanism can be used to maintain two portions of a frame in removably associated.

### RELATED APPLICATIONS

This application claims the benefit of the filing of U.S. Serial No. 60/331,926 entitled “Snap Hold Frame” filed on Nov. 21, 2001, hereby incorporated by reference.

### BACKGROUND OF THE INVENTION

The present invention is directed to a frame for holding glass or other opaque or transparent sheet material. In particular, the invention is directed to a retention or attachment mechanism for holding separate pieces of a frame together.

In the past, the separate pieces of a frame for holding glass were held together by screws or other threadable attachment elements which were threaded into threaded openings in the frame. Additionally, string or other cord was wrapped around the frame to keep the frame parts secured together. This had many draw-backs including but not limited to the time and expense incurred in screwing and unscrewing the frame pieces, stripping of the threads in the frame due to wear from the screwing and unscrewing of the frame pieces, and failure of the thread or cord to securely maintain the pieces together due to inadvertent slipping or loosing of the thread as a result of the shape of the frame or other stress factors.

These and other limitations and problems of the past are solved by the present invention.

### BRIEF SUMMARY OF THE INVENTION

A method and mechanism for securing two portions of a frame together is disclosed. In one embodiment, a frame for holding a sheet includes a first half of the frame and a second half of the frame with the sheet interposed between the first half of the frame and the second half of the frame. The first half and the second half of the frame have an interior face. A male member and female member are integral with the interior face. The female member and the male member are positioned in cooperative relationship with one another. In one aspect of the embodiment, a rib is located on the tip of the male member and within the bore of the female member. The tip of the male member is insertable within the bore of the female member so that the ribs are capable of engagement.

In another embodiment, a mechanism for joining two parts together includes a female member and a male member for insertion into the female member in a snap-fit relationship. In one aspect of this embodiment, the female member is an elongated slot. The male member is an elongated element having an external diameter less than the internal diameter of the elongated slot. A rib can be located within the elongated slot and on the elongated element, the ribs positioned in snap-fit relationship.

In yet another embodiment, a frame includes a first half and a second half each having an interior face. A plurality of female members are associated with the interior face and a plurality of male members are associated with the interior face. The male members and female members are positioned in cooperative relationship wherein the male members are capable of being inserted into the female members to removably attach the first half and the second half of the frame.

In another embodiment, a plastic frame for holding a sheet includes a first half of the frame having an exterior surface and an interior surface with the interior surface of the frame being substantially planar and a second half of the frame having an exterior surface and an interior surface with the interior surface of the frame being substantially planar. The sheet is interposed between the first half of the frame and the second half of the frame. A attachment mechanism having a plurality of first projections from the interior surface of the first half of the frame. The first projections having a base, a shaft, and a tip, a male portion located at the tip of the first projection. A plurality of second projections from the interior surface of the second half of the frame, the second projections having a base, a shaft, and a tip, a female portion located at the tip of the second projection. The male portion is capable of removable insertion into the female portion for removably associating the first half and the second half of the frame. In one aspect, a male rib is located on the male portion. In another aspect, the female portion is a bore. A rib may be located within the bore. The male rib and the female rib are capable of snap-fit association. In another aspect, a recess may be located on the male portion. Further, a rib may be located on the female portion, the female rib capable of snap-fit association with the recess on the male portion. This arrangement may be reversed with a recess in the female portion and a rib on the male portion, the male rib capable of snap-fit association with the recess in the female portion.

One embodiment of a method of joining a frame including positioning a first half of the frame having a first attachment member in cooperative relationship with a second half of the frame having a second attachment member, and associating the first attachment member and the second attachment member in a removable fashion whereby the first half and the second half are removably joined. In one aspect, the first attachment member is a male member and the second attachment member is a female member.

One advantage of the frame over other frames is the prevention of damage being done to the threads of a frame. Rather than screwing the two portions of a frame together followed by unscrewing the portions of the frame together for assembly with a door, the threads are not utilized until the first time the frame is assembled with the door leaving the threads in non-used condition.

The invention will best be understood by reference to the following detailed description of the preferred embodiment, taken in conjunction with the accompanying drawings. The discussion below is descriptive, illustrative and exemplary and is not to be taken as limiting the scope defined by any appended claims.

### BRIEF DESCRIPTION OF SEVERAL VIEWS OF THE DRAWINGS

FIG. 1 is a front view of a frame.

FIG. 2 is a cut-away view along line A-A of FIG. 1 showing one embodiment of the mechanism holding the two frame portions together.

FIG. 3 is an exploded view of one embodiment of the mechanism.

FIG. 4 is yet another exploded view of one embodiment of the mechanism.

### DETAILED DESCRIPTION OF THE INVENTION

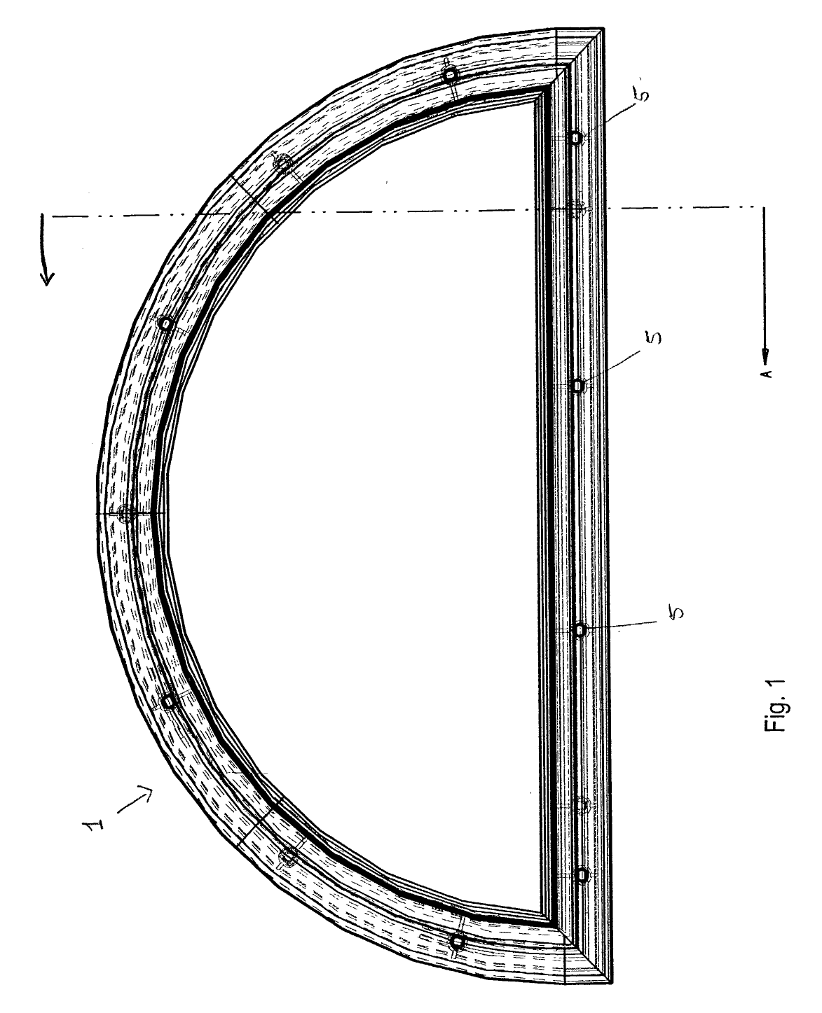

A frame 1 is shown in FIG. 1. The frame 1 shown in FIG. 1 is semi-circular in shape although any frame 1 shape can be used, including but not limited to a square, circle or rectangle. A plurality of threadable openings 5 are shown located in the frame 1. In one embodiment, the threadable openings 5 may be for acceptance of a screw, although other threaded members may be accepted. For example, but not limited to, the threaded openings 5 are threaded for reception of a threaded screw or other threaded element. In operation, screws are inserted into the threaded screw openings 5 for assembly with a door (not shown). As a further example, but not limited to, the frame 1 may also be assembled into a wall. Further, the semicircular frame 1 shown in FIG. 1 may be further divided into wedges.

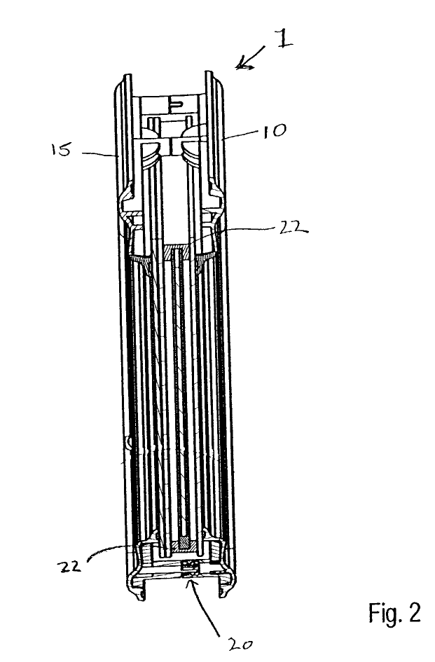

FIG. 2 shows a cut-away along line A-A of FIG. 1 of the frame 1. A first portion or half 10 and a second portion or half 15 making up the frame 1 are shown while removably coupled. One embodiment of the attachment mechanism 20 is shown for removably coupling the two portions together, such as two portions 10, 15 of a frame 1. For example, but not limited to frames 1, attachment mechanism 20 may be used to removably join or couple windows and other apparatuses. In another embodiment, a sheet 22 is capable of being held or interposed between the first half 10 and the second half 15 of the frame 1. The sheet 22 can be of glass or plastic. Further, the sheet may be opaque or transparent. In operation, a sheet 22 is removably held between the first portion 10 and the second portion 15 of the frame 1 with the aid of the attachment mechanism 20. In use, the first portion 10 and the second portion 15 of the frame 1 may be separated. The sheet 22 and one of the portions 10, 15 can be positioned on a first side of, for example, a door. The other portion 10, 15 can be positioned on the opposite side of the door for assembly with the door. Once in this position, the first portion 10 and the second portion 15 of the frame 1 can be assembled with the door. In one embodiment, the assembly is performed utilizing a threadable element threadable within the threaded opening 5. For example, a screw may be threaded to hold the sheet 22 and door between the first portion 10 and the second portion 15.

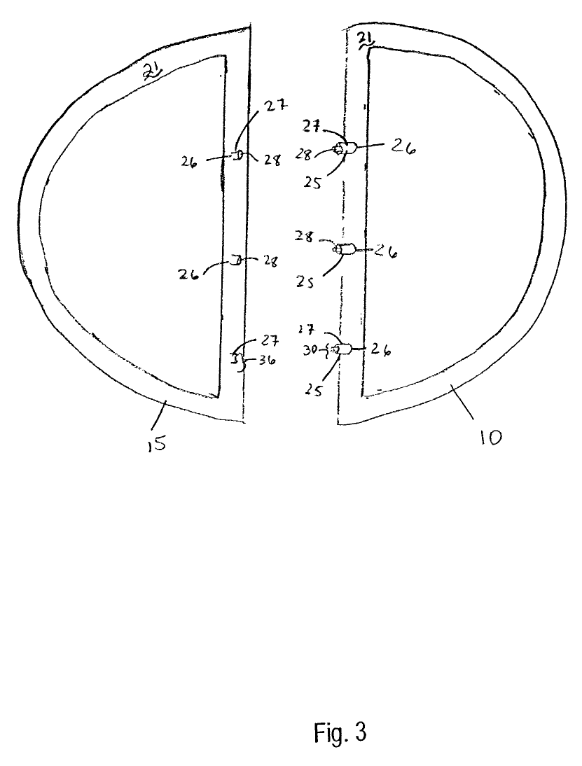

As shown in FIG. 3, in one embodiment, the attachment mechanism 20 includes a plurality of first projections 25 from the interior surface 21 of the first half 10 of the frame 1. The first projections 25 have a base 26, a shaft 27, and a tip 28. A male portion 30 is located at the tip 28 of the first projection 25. The attachment mechanism 20 also includes a plurality of second projections 35 from the interior surface 21 of the second half 15 of the frame. The second projections 35 also have a base 26, a shaft 27, and a tip 28. A female portion 36 is located at the tip 28 of the second projection 35. The male portion 30 is capable of removable insertion into the female portion 36 for removably associating the first half 10 and the second half 15 of the frame 1. The male portion 30 has a diameter slightly smaller than the diameter of the female portion 36 so that a snug relationship between the male portion 30 and the female portion 36 may be created. In one aspect of this embodiment, the male portion 30 and the female portion 36 do not require a base 26 and a shaft 27. Rather, the male portion 30 is capable of insertion into the female portion 36.

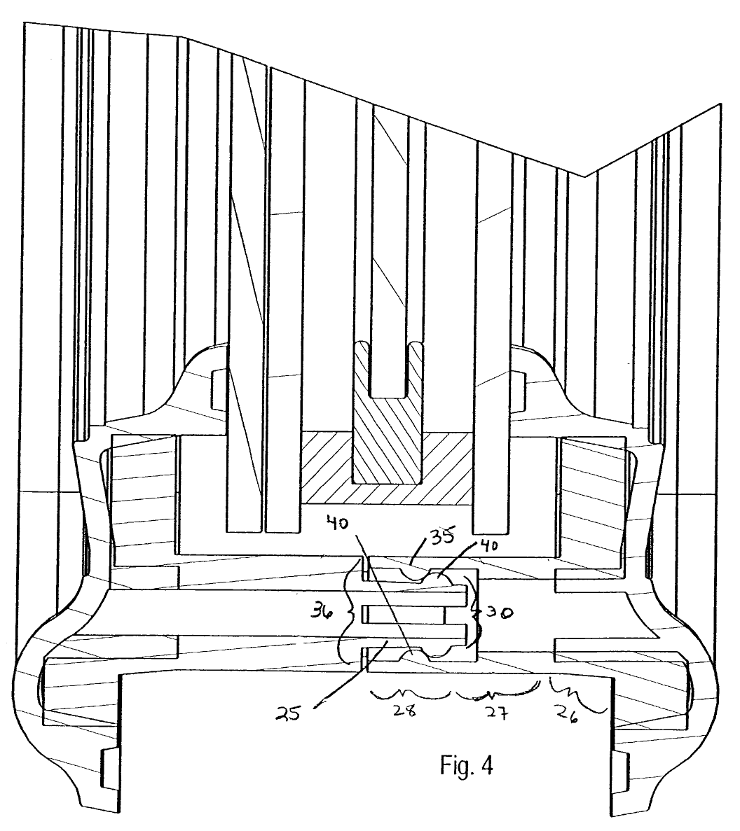

In another embodiment, FIG. 4 shows the female portion 36 and the male portion 30 in snap-fit relationship. The male portion 30 and the female portion 36 have ribs 40 which cooperate to maintain the first portion 10 and the second portion 15 of the frame 1 removably associated. It is understood that in one embodiment the male portion 30 and the female portion 36 may include ribs 40 while in other embodiments, the male portion 30 and female portion 36 may also include recess (not shown) 41 and ribs 40 in cooperative relationship.

In yet another embodiment, the attachment mechanism 20 on the frame 1 may include a female portion 36 which is planar or substantially planar with the interior surface 21 of the first portion 10 of the frame 1. The second portion 15 of the frame 1 includes a male portion 30. The male portion 30 is capable of insertion into the female portion 36. The relationship between the male portion 30 and the female portion 36 is such that a snug or snap-fit relationship is created. The male portion 30 is easily inserted into the female portion 36 and securely retained therein in a removable manner.

In another embodiment, the attachment mechanism 20 may include a female portion 36 in the form of a slot or elongated, rather than rounded, opening. The slot may be located on a second projection 35 from the interior surface 21 of the frame 1 or may be planar or substantially planar with the interior surface 21 of the frame 1. Capable of association within the slot is an elongated male portion 30 having a shape complementary to and/or cooperative with the female portion 36 of the attachment mechanism 20. The male portion 30 may be the tip 28 of a first projection 25. Alternatively, the male portion 30 may be a stand-alone male portion 30. In one aspect of the embodiment, the male portion 30 may have a rib 40 located on it which is capable of cooperative association with a rib 40 located on the female portion 36. Alternatively, the female portion 36 may have a recess 41 located within it which is capable of receiving in cooperative manner the rib 40 of the male portion 30. Further, this relationship may be reversed wherein the male portion 30 may have a recess located on it and the female portion 36 may have a rib 40 located within it.

In other embodiments, the frame 1 may have one or a plurality of attachment mechanisms 20. The attachment mechanisms 20 may be located a various positions about the interior surface 21 of the frame 1.

One method of joining a first portion 10 and a second portion 15 of a frame 1 includes positioning a first portion 10 of the frame 1 having an attachment member 20 in cooperative relationship with a second portion 15 of the frame 1 having an attachment member 20. The attachment members 20 are associated in a removable fashion whereby the first portion 10 and the second portion 15 are removably joined or coupled. The attachment member 20 includes a male portion 30 (or member) and a female member 36 (or member).

No license is expressly or implicitly granted to any patent or patent applications referred to or incorporated herein. The discussion above is descriptive, illustrative and exemplary and is not to be taken as limiting the scope defined by any appended claims.

1. A frame for holding a sheet comprising:
(a) a first half of the frame;
(b) a second half of the frame, the sheet interposed between the first half of the frame and the second half of the frame;
(c) an interior face of the first half and the second half of the frame;
(d) a male member integral with the interior face; and
(e) a female member integral with the interior face, wherein the female member and the male member are positioned in cooperative relationship.

2. The frame of claim 1 wherein the sheet is glass

3. The frame of claim 1 wherein the sheet is plastic.

4. The frame of claim 3 wherein the plastic is translucent

5. The frame of claim 3 wherein the plastic is opaque.

6. The frame of claim 1 wherein the male member is a projection, the projection having a tip.

7. The frame of claim 6 wherein the female member is a bore.

8. The frame of claim 7 wherein the tip is tapered.

9. The frame of claim 8 further comprising
a rib located on the tip of the male member and within the bore of the female member, the tip of the male member insertable within the bore of the female member so that the ribs are capable of engagement.

10. A mechanism for joining two parts together comprising:
(a) a female member; and
(b) a male member for insertion into the female member in a snapfit relationship.

11. The mechanism of claim 10 wherein the female member is an elongated slot, the elongated slot having an internal diameter.

12. The mechanism of claim 11 wherein the male member is an elongated element having an external diameter less than the internal diameter of the elongated slot.

13. The mechanism of claim 12 further comprising
a rib located within the elongated slot and on the elongated element, the ribs positioned in snap-fit relationship.

14. The mechanism of claim 12 further comprising
a rib located on the elongated element;
a recess located in the elongated slot, wherein the elongated member is capable of insertion within the elongated slot and the rib on the elongated member associable with the recess in the elongated slot.

15. The mechanism of claim 10 wherein the female member is a bore and the male member is a projection.

16. A frame comprising:
(a) a first half and a second half, the first half and the second half each having an interior face;
(b) a plurality of female members associated with the interior face and a plurality of male members associated with the interior face, the male members and female members positioned in cooperative relationship wherein the male members are capable of being inserted into the female members to removably attach the first half and the second half of the frame.

17. An apparatus for holding together a frame comprising:
(a) a female member associated with the frame;
(b) a male member associated with the frame and capable of removable engagement with the female member.

18. A method of joining a frame comprising:
(a) positioning a first half of the frame having a first attachment member in cooperative relationship with a second half of the frame having a second attachment member; and
(b) associating the first attachment member and the second attachment member in a removable fashion whereby the first half and the second half are removably joined.

19. The method of claim 18 wherein the first attachment member is a male member and the second attachment member is a female member.

20. A plastic frame for holding a sheet comprising:
(a) a first half of the frame, the first half of the frame having an exterior surface and an interior surface of the frame, the interior surface of the frame being substantially planar;
(b) a second half of the frame, the second half of the frame having an exterior surface and an interior surface of the frame, the interior surface of the frame being substantially planar, the sheet interposed between the first half of the frame and the second half of the frame; and
(c) an attachment mechanism having
(i) a plurality of first projections from the interior surface of the first half of the frame, the first projections having a base, a shaft, and a tip, a male portion located at the tip of the first projection;
(ii) a plurality of second projections from the interior surface of the second half of the frame, the second projections having a base, a shaft, and a tip, a female portion located at the tip of the second projection, whereby the male portion is capable of removable insertion into the female portion for removably associating the first half and the second half of the frame.

21. The frame of claim 20 wherein the sheet is selected from the group consisting of glass and plastic.

22. The frame of claim 21 wherein the plastic is opaque.

23. The frame of claim 21 where the plastic is translucent.

24. The frame of claim 20 further comprising
a male rib located on the male portion.

25. The frame of claim 20 wherein the female portion is a bore.

26. The frame of claim 25 further comprising a rib located within the bore.

27. The frame of claim 24 further comprising a female rib located within the female portion, the male rib and the female rib capable of snap-fit association.

28. The frame of claim 20 further comprising a recess on the male portion.

29. The frame of claim 28 further comprising a rib on the female portion, the female rib capable of snap-fit association with the recess on the male portion.

30. The frame of claim 20 further comprising
a recess in the female portion.

31. The frame of claim 30 further comprising
a rib on the male portion, the male rib capable of snap-fit association with the recess in the female portion.
